(19) United States
(12) Patent Application Publication
(10) Pub. No.: US 2010/0292422 A1
(43) Pub. Date: Nov. 18, 2010

(54) METHOD FOR PRODUCING COPOLYMERS MADE FROM ISOBUTENE AND AT LEAST ONE VINYLAROMATIC COMPONENT

(75) Inventors: Hans Peter Rath, Gruenstadt (DE); Hans-Michael Walter, Freinsheim (DE); Oskar Nuyken, Muenchen (DE); Fritz Elmar Kuehn, Nandlstadt (DE); Yanmei Zhang, Muenchen (CN); Hui Yee Yeong, Perak (MY); Brigitte Voit, Dresden (DE); Radha Krishnan Narayanan, Dresden (IN)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/063,034

(22) PCT Filed: Aug. 11, 2006
(86) PCT No.: PCT/EP06/65272

§ 371 Date: Feb. 6, 2008

(30) Foreign Application Priority Data
Aug. 12, 2005 (DE) 10 2005 038 282.7

(51) Int. Cl. C08F 4/44

(52) U.S. Cl. 526/134

(57) ABSTRACT

The invention relates to a method for producing copolymers made from isobutene and at least one vinylaromatic component. Said method consists of polymerising isobutene or a hydrocarbon mixture containing isobutene with at least one vinylaromatic compound in the presence of a solvent-stable transistion metal complex comprising slightly co-ordinating anions as a polymerisation catalyst. The invention also relates to copolymers made of isobutene and at least one vinylaromatic compound, which can be obtained by means of said inventive method, in addition to specific functionalisation products therefrom.

The present invention relates to a process preparing copolymers from isobutene and at least one vinylaromatic compound, especially isobutene-styrene copolymers, in which isobutene or an isobutenic hydrocarbon mixture and at least one vinylaromatic compound, for example styrene, are polymerized in the presence of a solvent-stabilized transition metal complex with weakly coordinating anions as a polymerization catalyst. The invention also relates to copolymers of isobutene and at least one vinylaromatic compound which are obtainable by the process according to the invention and which are preferably highly reactive, and also to certain functionalization products thereof.

Highly reactive copolymers of isobutene and at least one vinylaromatic compound are understood to mean those copolymers which comprise a high content of terminal ethylenic double bonds. In the context of the present invention, highly reactive copolymers of isobutene and at least one vinylaromatic compound shall be understood to mean those copolymers which have a content of vinylidene double bonds (α-double bonds) of at least 60 mol %, preferably of at least 70 mol % and in particular of at least 80 mol %, based on the copolymer macromolecules. In the context of the present invention, vinylidene groups is understood to mean those double bonds whose position in the copolymer macromolecule is described by the general formula

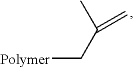

i.e. the double bond is in the α-position in the polymer chain. “Polymer” represents the copolymer radical shortened by one isobutene unit. The vinylidene groups exhibit the highest reactivity, whereas a double bond lying further toward the interior of the macromolecules exhibits no or in any case less reactivity in functionalization reactions.

Isobutene-styrene copolymers and especially isobutene-styrene block copolymers have both thermoplastic and elastic properties, have higher tear resistance and have a higher surface hardness than pure polyisobutene. Owing to the presence of copolymerized styrene and especially of styrene blocks, they exhibit thermoplastic behavior and are therefore easy to process, for example by melt extrusion. They are therefore suitable for use in films, sealing materials, adhesives, adhesion promoters and the like.

Processes for preparing isobutene-styrene block copolymers are known. In general, the polymerization is effected in such a way that isobutene is first polymerized under cationic conditions and the polymer chain formed is then reacted further with styrene.

U.S. Pat. No. 4,946,899 describes a process for preparing isobutene-styrene diblock copolymers, triblock copolymers or star-shaped copolymers by living cationic polymerization of isobutene onto a living polyisobutene chain which is then polymerized further with styrene in the presence of an electron pair donor.

WO 01/10969 describes linear or star-shaped isobutene-styrene block copolymers with a central isobutene block which are obtainable by polymerizing isobutene in the presence of an at least difunctional initiator molecule and of a Lewis acid under the conditions of a living cationic polymerization, and then allowing the living chain ends to react further with styrene.

These prior art processes give rise to copolymers which are terminated at their chain ends by groups which derive from styrene. However, a disadvantage of such chain ends is that they cannot be functionalized directly. For numerous applications, it is, however, necessary to be able to functionalize the chain ends further, for example by the introduction of polar groups.

A further disadvantage of the prior art processes is that they require low temperatures, usually distinctly below 0° C.

EP-A 1344785 describes a process for preparing highly reactive polyisobutene homo- or copolymers using a solvent-stabilized transition metal complex with weakly coordinating anions as a polymerization catalyst. The polymerization can also be carried out at reaction temperatures above 0° C., but a disadvantage is that the polymerization times are very long. Described specifically is the copolymerization of isobutene and isoprene. The preparation of highly reactive copolymers from isobutene and at least one vinylaromatic compound, however, is not mentioned.

It was an object of the present invention to provide a process for preparing copolymers from isobutene and at least one vinylaromatic compound, which does not have the abovementioned disadvantages of the prior art processes.

The object is achieved by a process for preparing copolymers which are formed from monomers comprising isobutene and at least one vinylaromatic compound, which comprises polymerizing isobutene or an isobutenic hydrocarbon mixture and at least one vinylaromatic compound in the presence of a catalyst of the formula I

[M(L)ₐ(Z)_{b}]^{m+}m(A⁻) (I)

in which
M is a transition metal of group 3 to 12 of the periodic table, a lanthanide or a metal of group 2 or 13 of the periodic table;
L is a solvent molecule;
Z is a singly or multiply charged ligand;
A⁻ is a weakly coordinating or noncoordinating anion;
a is an integer greater than or equal to 1;
b is 0 or an integer greater than or equal to 1;
where the sum of a and b is from 4 to 8; and
m is an integer from 1 to 6.

The remarks which follow regarding suitable and preferred embodiments of the subject matter of the invention, especially regarding the monomers and catalysts used in the process according to the invention, regarding the reaction conditions and regarding the polymers thus obtainable apply both taken alone and especially in combination with one another.

In the context of the present invention, the following definitions apply for radicals defined in general:

C₁-C₄-Alkyl is a linear or branched alkyl radical having from 1 to 4 carbon atoms. Examples thereof are methyl, ethyl, n-propyl, isopropyl, n-butyl, 2-butyl, isobutyl or tert-butyl. C₁-C₂-Alkyl is methyl or ethyl, C₁-C₃-alkyl is additionally n-propyl or isopropyl.

C₁-C₈-Alkyl is a linear or branched alkyl radical having from 1 to 8 carbon atoms. Examples thereof are the abovementioned C₁-C₄-alkyl radicals and additionally pentyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, heptyl, octyl and their constitutional isomers such as 2-ethylhexyl.

C₁-C₄-Haloalkyl is a linear or branched alkyl radical which has from 1 to 4 carbon atoms and is substituted by at least one halogen radical. Examples thereof are CH₂F, CHF₂, CF₃, CH₂Cl, CHCl₂, CCl₃, CH₂FCH₂, CHF₂CH₂, CF₃CH₂ and the like.

In the context of the present invention, aryl is optionally substituted phenyl, optionally substituted naphthyl, optionally substituted anthracenyl or optionally substituted phenanthrenyl. The aryl radicals may bear from 1 to 5 substituents which are, for example, selected from hydroxyl, C₁-C₈-alkyl, C₁-C₈-haloalkyl, halogen, NO₂ or phenyl. Examples of aryl are phenyl, naphthyl, biphenyl, anthracenyl, phenanthrenyl, tolyl, nitrophenyl, hydroxyphenyl, chlorophenyl, dichlorophenyl, pentafluorophenyl, pentachlorophenyl, (trifluoromethyl)phenyl, bis(trifluoromethyl)phenyl, (trichloro)methylphenyl, bis(trichloromethyl)phenyl and hydroxynaphthyl.

In the context of the present invention, arylalkyl is an aryl group which is bonded via an alkylene group. Examples thereof are benzyl and 2-phenylethyl.

C₁-C₄-Carboxylic acids represent aliphatic carboxylic acids having from 1 to 4 carbon atoms. Examples thereof are formic acid, acetic acid, propionic acid, butyric acid and isobutyric acid.

C₁-C₄-Alcohol represents a C₁-C₄-alkyl radical as defined above, in which at least one hydrogen atom has been replaced by a hydroxyl group. It preferably represents a monohydric alcohol, i.e. a C₁-C₄-alkyl group in which one hydrogen atom has been replaced by a hydroxyl group. Examples thereof are methanol, ethanol, propanol, isopropanol, n-butanol, sec-butanol, isobutanol and tert-butanol.

In the context of the present invention, halogen is fluorine, chlorine, bromine or iodine.

In the context of the present invention, vinylaromatic compounds are styrene and styrene derivatives such as α-methylstyrene, C₁-C₄-alkylstyrenes, such as 2-, 3- or 4-methylstyrene and 4-tert-butylstyrene, and halostyrenes such as 2-, 3- or 4-chlorostyrene. Preferred vinylaromatic compounds are styrene and 4-methylstyrene and also mixtures thereof, particular preference being given to styrene.

Transition metals of group 3 to 12 are also known as metals of transition group I. to VIII. or are referred to simply as transition metals.

Examples of suitable transition metals are titanium, zirconium, vanadium, chromium, molybdenum, tungsten, manganese, iron, ruthenium, osmium, cobalt, rhodium, nickel, palladium, platinum, copper and zinc. Preferred transition metals are vanadium, chromium, molybdenum, manganese, iron, cobalt, nickel, copper and zinc, particular preference being given to manganese.

Lanthanides are understood to mean metals having the atomic number 58 to 71 in the periodic table, such as cerium, praseodymium, neodymium, samarium and the like. Preferred lanthanides are cerium and samarium.

The metals of group 2 or 13 of the periodic table are also referred to as metals of main group 2 or 3. Examples thereof are beryllium, magnesium, calcium, aluminum and gallium. Preferred main group metals are magnesium and aluminum.

When M is a transition metal of group 3 to 12 of the periodic table, it is preferably selected from vanadium, chromium, molybdenum, manganese, iron, cobalt, nickel, copper and zinc.

When M is a lanthanide, it is preferably selected from cerium and samarium.

When M is a metal of group 2 or 13 of the periodic table, it is preferably selected from magnesium and aluminum.

M is more preferably a transition metal of group 3 to 12 of the periodic table. More preferably, M is a transition metal which is selected from vanadium, chromium, molybdenum, manganese, iron, cobalt, nickel, copper and zinc. In particular, M is manganese.

In the catalyst of the formula I, the central metal M may assume an oxidation number of I to VII. M is present preferably in an oxidation number of II, III or IV, more preferably of II or III and in particular of II.

L is a solvent molecule which can bind coordinatively. These are molecules which are typically used as a solvent but simultaneously have at least one dative moiety, i.e. a free electron pair which can enter into a coordinative bond to the central metal. Examples thereof are nitriles such as acetonitrile, propionitrile and benzonitrile, open-chain and cyclic ethers such as diethyl ether, dipropyl ether, diisopropyl ether, methyl tert-butyl ether, ethyl tert-butyl ether, tetrahydrofuran and dioxane, carboxylic acids, in particular C₁-C₄-carboxylic acids such as formic acid, acetic acid, propionic acid, butyric acid and isobutyric acid, carboxylic esters, in particular the esters of C₁-C₄-carboxylic acids with C₁-C₄-alcohols, such as ethyl acetate and propyl acetate, and carboxamides, in particular of C₁-C₄-carboxylic acids with di(C₁-C₄-alkyl)amines, such as dimethylformamide.

Preferred solvent molecules are those which firstly bind coordinatively to the central metal but secondly are not strong Lewis bases, so that they can be displaced readily from the coordination sphere of the central metal in the course of the polymerization. The solvent ligands L, which may be the same or different, are preferably selected from nitriles of the formula N≡C—R¹ in which R¹ is C₁-C₈-alkyl or aryl, and open-chain and cyclic ethers.

In the nitriles, the R¹ radical is preferably C₁-C₄-alkyl or phenyl. Examples of such nitriles are acetonitrile, propionitrile, butyronitrile, pentylnitrile and benzonitrile. More preferably, R¹ is methyl, ethyl or phenyl, i.e. the nitrile is more preferably selected from acetonitrile, propionitrile and benzonitrile. In particular, R¹ is methyl or phenyl, i.e. the nitrile is in particular acetonitrile or benzonitrile. R¹ is especially methyl, i.e. the nitrile is especially acetonitrile.

Suitable open-chain and cyclic ethers are, for example, diethyl ether, dipropyl ether, diisopropyl ether, methyl tert-butyl ether, ethyl tert-butyl ether, tetrahydrofuran and dioxane, preference being given to diethyl ether and tetrahydrofuran.

More preferably, L is a nitrile of the formula N≡C—R¹ in which R¹ is preferably methyl, ethyl or phenyl, more preferably methyl or phenyl and in particular methyl.

L may be the same or different solvent molecules. In compound I, however, all L are preferably the same solvent ligand.

Z derives from a singly or multiply charged anion and thus differs from the ligand L in particular by the charge and also by the stronger coordination to the central metal M.

Z may either be a charged monodentate ligand or a singly or a multiply charged bi- or multidentate ligand.

Examples of charged monodentate ligands are halides, pseudohalides, hydroxyl, nitrite (NO₂⁻), alkoxides and acid anions.

Examples of singly or multiply charged bi- or multidentate ligands are di- and polycarboxylic acid anions, acetyl acetonate and ethylenediaminetetraacetate (EDTA).

Halides are, for example, fluoride, chloride, bromide and iodide, preference being given to chloride and bromide. Halide is more preferably chloride.

Pseudohalides are, for example, cyanide (CN⁻), thiocyanate (SCN⁻), cyanate (OCN⁻), isocyanate (CNO⁻) and azide (N₃⁻). Preferred pseudohalides are cyanide and thiocyanate.

Suitable alkoxides are compounds of the formula RO⁻ in which R is C₁-C₈-alkyl or arylalkyl. R is preferably C₁-C₄-alkyl or benzyl. Examples of such alkoxides are methoxide, ethoxide, propoxide, isopropoxide, n-butoxide, isobutoxide, tert-butoxide and benzylalkoxide.

Suitable acid anions are the acid anions of aliphatic or aromatic monocarboxylic acids having from 1 to 8 carbon atoms, such as formic acid, acetic acid, propionic acid, butyric acid, isobutyric acid, valeric acid, isovaleric acid, caproic acid, caprylic acid and benzoic acid.

Suitable dicarboxylic acid anions are the mono- and dianions of aliphatic or aromatic dicarboxylic acids having from 2 to 10 carbon atoms, such as oxalic acid, malonic acid, succinic acid, glutaric acid, adipic acid, pimelic acid, azelaic acid, sebacic acid and phthalic acid.

Suitable polycarboxylic acid anions are the mono- and polyanions of polycarboxylic acids such as citric acid or else the oligomers of ethylenically unsaturated carboxylic acids such as acrylic acid or methacrylic acid.

Z derives preferably from a monodentate singly charged anion. Z more preferably derives from a halide or pseudohalide and more preferably from a halide. In particular, Z derives from chloride.

The definition of the index b depends upon whether the ligand Z is a monodentate or else a multidentate ligand. When Z is a bi- or multidentate ligand, the index b is the number of binding sites with which this ligand Z coordinates to the metal multiplied by the number of these bi- or multidentate ligands which are coordinated to M. For monodentate ligands Z, b is of course just the number of coordinatively bound ligands.

The coordination number of the metal, i.e. the sum of a and b, is from 4 to 8 in accordance with the invention. It is required that at least one ligand L is present in the coordination sphere of the metal.

a is preferably an integer from 1 to 6, more preferably an integer from 4 to 6, in particular 5 or 6 and especially 6.

b is preferably 0 or an integer from 1 to 4, more preferably 0 or 1 and especially 0.

The sum of a and b is preferably from 4 to 6. It is more preferably 6. In this case, the metal complexes are present preferably in octahedral or virtually octahedral form.

m is preferably an integer from 1 to 3. m is especially 2.

A⁻ is a weakly coordinating or noncoordinating anion. Weakly coordinating or noncoordinating anions are those which do not enter into a coordinative bond with the central atom, and which thus do not have a Lewis-basic moiety. Generally, the weakly coordinating or noncoordinating anions are those whose negative charge is delocalized over a large surface of non-nucleophilic and chemically robust groups. For example, weakly coordinating or noncoordinating anions are mono- or binuclear anions with a Lewis-acidic central atom whose electron deficiency is, however, compensated by the binding of a weakly coordinating substituent.

The weakly coordinating or noncoordinating anion K is preferably selected from BX₄⁻, B(Ar)₄⁻, bridged anions of the formula [(Ar)₃B-(μ-Y)—B(Ar)₃]⁻, SbX₆⁻, Sb₂X₁₁⁻, AsX₆⁻, As₂X₁₁⁻, ReX6⁻, Re₂X₁₁⁻, AlX₄⁻, Al₂X₇⁻, OTeX₅⁻, B(OTeX₅)₄⁻, Nb(OTeX₅)₆⁻, [Zn(OTeX₅)₄]₂⁻, OSeX₅⁻, trifluoromethanesulfonate, perchlorate, carborates and carbon cluster anions, where
Ar is phenyl which may bear from 1 to 5 substituents which are selected from halogen, C₁-C₄-alkyl and C₁-C₄-haloalkyl;
Y is a bridging group; and
X is fluorine or chlorine.

Ar is, for example, phenyl, pentafluorophenyl or bis(trifluoromethyl)phenyl, e.g. 3,5-bis(trifluoromethyl)phenyl. Ar in the anion B(Ar)₄⁻ is preferably a substituted phenyl, more preferably bis(trifluoromethyl)phenyl, e.g. 3,5-bis(trifluoromethyl)phenyl, or in particular pentafluorophenyl. In the bridged anions too, Ar is preferably a substituted phenyl group, more preferably bis(trifluoromethyl)phenyl, e.g. 3,5-bis(trifluoromethyl)phenyl, or in particular pentafluorophenyl.

The bridging group Y may, for example, be CN, NH₂ or a cyclic bridging unit. Cyclic bridging units are those cycles which are bonded via two Lewis-basic moieties. Examples thereof are saturated or unsaturated heterocycles having at least 2 heteroatoms, preferably having at least 2 nitrogen atoms, such as pyrazolediyl, pyrazolinediyl, pyrazolidinediyl, imidazolediyl, imidazolinediyl, imidazolidinediyl, triazolediyl, triazolinediyl, triazolidinediyl, pyrimidinediyl, pyrazinediyl and pyridazinediyl. Preference is given to aromatic heterocycles. Particularly preferred cyclic bridging units are imidazol-1,3-yl and triazolediyl, e.g. [1,2,4]triazole-2,4-diyl.

Y is preferably selected from cyclic bridging groups, particular preference being given to triazolediyl and in particular imidazol-1,3-yl.

X is preferably fluorine.

In the context of the present invention, carborates are understood to mean the anions of carboranes, i.e. of cage-like boron-carbon compounds, for example the anions of closo-, nido- or arachno-carboranes. Examples thereof are the following closo-carborates: [CB₁₁H₁₂]⁻, [CB₉H₁₀]⁻ and [CB₁₁(CH₃)₁₂]⁻. However, preference is given to those carborates in which some of the hydrogen atoms have been substituted by halogen atoms. Examples thereof are [CB₁₁H₆Cl₆]⁻, [1-H—CB₁₁(CH₃)₅Cl₆]⁻, [CB₁₁H₆F₆]⁻ and [1-H—CB₁₁(CH₃)₅F₆]⁻.

In the context of the present invention, carbon cluster anions are understood to mean the anions of carbon clusters, for example of fullerenes. An example thereof is C₆₀⁻.

The weakly coordinating or noncoordinating anion A⁻ is more preferably selected from BX₄⁻, B(Ar)₄⁻, bridged anions of the formula [(Ar)₃B-(μ-Y)—B(Ar)₃]⁻, SbX₆⁻, Sb₂X₁₁⁻, AsX₆⁻, As₂X₁₁⁻, ReX₆⁻, Re₂X₁₁⁻, AlX₄⁻, Al₂X₇⁻, OTeX₅⁻, B(OTeX₅)₄⁻, Nb(OTeX₅)₆⁻, [Zn(OTeX₅)₄]₂⁻, OSeX₅⁻, trifluoromethanesulfonate and perchlorate.

More preferred weakly coordinating or noncoordinating anions A⁻ are selected from B(Ar)₄⁻ and bridged anions of the formula [(Ar)₃B-(μ-Y)—B(Ar)₃]⁻. Preference is given to those borates B(Ar)₄⁻ in which Ar is 3,5-bis(trifluoromethyl)phenyl or in particular pentafluorophenyl. Preferred bridged anions are those in which Ar is pentafluorophenyl and Y is an imidazole-1,3 bridge.

Particularly preferred catalysts of the formula I are those in which M is V, Cr, Mo, Mn, Fe, Co, Ni or Zn and in particular Mo, Mn, Fe, Ni or Cu, L is acetonitrile (CH₃CN) or benzonitrile (C₆H₅CN) and especially acetonitrile, X is chloride, a is 5 or 6, b is 0 or 1, the sum of a and b is 6, m is 1 or 2 and A⁻ is B(Ar)₄⁻ or a bridged anion of the formula [(Ar)₃B-(μ-Y)—B(Ar)₃]⁻. In particular, the catalyst I is [Mo(CH₃CN)₅Cl]²⁺ 2[A⁻] or especially [Mn(CH₃CN)₆]²⁺ 2[A⁻], where A⁻ is B(Ar)₄⁻ in which Ar is 3,5-bis(trifluoromethyl)phenyl or in particular pentafluorophenyl, or where K is a bridged anion of the formula [(Ar)₃B-(μ-Y)—B(Ar)₃]⁻ in which Ar is pentafluorophenyl and Y is an imidazole-1,3 bridge.

The catalysts of the formula I can be prepared by commonly known processes for preparing transition metal complexes with solvent molecules in the coordination sphere. The weakly coordinating or noncoordinating anion A⁻ can be introduced in analogy to the known processes, as described, for example, in W. E. Buschmann, J. S. Miller, Chem. Eur. J. 1998, 4(9), 1731, R. E. LaPointe, G. R. Ruff, K. A. Abboud, J. Klosin, New Family of Weakly Coordinating Anions, J. Am. Chem. Soc. 2000, 122(39), 9560, W. E. Buschmann, J. S. Miller, Inorganic Chemistry 33, 2002, 83, O. Nuyken, F. E. Kühn, Angew. Chem. Int. Ed. Engl. 2003, 42, 1307, O. Nuyken, F. E. Kühn, Chem. Eur. J. 2004, 10, 6323 and EP-A-1344785, and also in the literature cited therein, which are hereby fully incorporated by reference.

For example, the catalyst of the formula I can be prepared by dissolving a salt of the formula M^{x+}Z^{y-}_{x/y} in a solvent which corresponds to the solvent molecule L. In the case that Z is not Cl, a salt of the formula M^{x+}(Cl⁻)ₓ is added as well or instead. To introduce the anion A⁻, this solution is then admixed with a silver salt of the appropriate anion, especially with [Ag(L)₄]⁺(A⁻), preferably at a temperature of from −10° C. to room temperature. The silver chloride which precipitates is removed from the reaction solution, for example by filtration, decanting or centrifugation. Subsequently, the solvent is generally at least partly removed, which can be done, for example, by distillation, especially under reduced pressure. The catalyst I can be isolated by customary processes, for example by removing the solvent to dryness or preferably by crystallization in suitable solvents.

Alternatively, isolated mono- or polynuclear complexes of the metal M with Z and L as ligands of the above-described ion exchange method can be subjected to the introduction of the anion A. Such isolable solvent complexes can be prepared in analogy to processes as described, for example, in F. A. Cotton, R. H. Niswander, J. C. Sekutowski, Inorg. Chem. 1979, 18, 1149, I. R. Anderson, J. C. Sheldon, Aust. J. Chem. 1965, 18, 271, J. V. Brencic, F. A. Cotton, Inorg. Chem. 1969, 8, 7 and R. W. McGaff, N. C. Dopke, R. K. Hayashi, D. R. Powell, P. M. Treichel, Polyhedron 2000, 19, 1245 and in the literature cited therein, which is hereby fully incorporated by reference.

In the process according to the invention, the catalysts of the formula I are used in relation to the monomers used in the molar ratio of from 1:10 to 1:1 000 000, more preferably from 1:5000 to 1:500 000 and in particular from 1:5000 to 1:100 000, for example from 1:10 000 to 1:100 000.

The concentration of the catalysts I used in the reaction mixture is in the range from preferably 0.01 mmol/l to 5 mmol/l, particularly preferably from 0.01 to 1 mmol/l, more preferably from 0.01 to 0.5 mmol/l and in particular from 0.01 to 0.1 mmol/l.

Suitable isobutene sources are both isobutene itself and isobutenic hydrocarbon mixtures, for example isobutenic C₄ hydrocarbon streams such as C₄ raffinates, C₄ cuts from isobutane dehydrogenation or C₄ cuts from steam crackers and from FCC crackers (fluid catalyzed cracking), provided that they have been freed substantially of 1,3-butadiene present therein. Suitable C₄ hydrocarbon streams comprise generally less than 500 ppm, preferably less than 200 ppm, of butadiene. The presence of 1-butene and also of cis- and trans-2-butene is substantially uncritical. Typically, the isobutene concentrations in the C₄ hydrocarbon streams are in the range from 40 to 60% by weight. The isobutenic monomer mixture may comprise small amounts of contaminants such as water, carboxylic acids or mineral acids without there being critical losses of yield or selectivity. It is appropriate to the purpose to prevent enrichment of these impurities by removing such harmful substances from the isobutenic monomer mixture, for example by adsorption on solid adsorbents such as activated carbon, molecular sieves or ion exchangers.

The vinylaromatic compounds are used in the process according to the invention in an amount of preferably from 5 to 95% by weight, more preferably from 30 to 70% by weight, based on the total weight of vinylaromatic compounds and isobutene.

In the process according to the invention, it is also possible to polymerize monomer mixtures which, in addition to isobutene or the isobutenic hydrocarbon mixture and the at least one vinylaromatic compound, also comprise further olefinically unsaturated comonomers which are copolymerizable with isobutene and the vinylaromatic compound. When monomer mixtures with further comonomers are to be used in the process according to the invention, these comonomers are present in an amount of preferably at most 15% by weight, more preferably at most 10% by weight and in particular at most 5% by weight, based on the total weight of the monomer mixture.

Useful copolymerizable monomers are isoolefins having from 5 to 10 carbon atoms such as 2-methylbutene-1,2-methylpentene-1,2-methylhexene-1,2-ethylpentene-1,2-ethylhexene-1 and 2-propylheptene-1. Useful comonomers are also olefins which have a silyl group such as 1-trimethoxysilylethene, 1-(trimethoxysilyl)propene, 1-(trimethoxysilyl)-2-methylpropene-2,1-[tri(methoxyethoxy)silyl]ethene, 1-[tri(methoxyethoxy)silyl]propene and 1-[tri(methoxyethoxy)silyl]-2-methylpropene-2.

Processes for copolymerizing different comonomers can generally be performed such that preferentially random polymers or preferentially block copolymers are formed. To prepare block copolymers, the procedure is generally to add the different monomers successively to the polymerization reaction, the second comonomer being added especially not until the first comonomer has at least partly already polymerized. In this way, it is possible to obtain diblock copolymers, triblock copolymers and higher block copolymers which, depending on the sequence of monomer addition, have a block of one or another comonomer as a terminal block. In this way, it is possible by the process according to the invention to obtain block copolymers which have either a polyisobutene block or a block of the vinylaromatic compound as a terminal block. In the case of successive addition of the monomers, preference is given to adding isobutene as the last monomer, so as to form block copolymers having a terminal polyisobutene block. Surprisingly, block copolymers which generally have a terminal polyisobutene block are also formed in the process according to the invention when all comonomers are added simultaneously to the polymerization reaction. This is attributable to the vinylaromatic compounds, especially styrene, polymerizing significantly more rapidly than isobutene.

The polymerization can be effected either continuously or batchwise. Continuous processes can be performed in analogy to known prior art processes for continuously polymerizing isobutene in the presence of Lewis acid catalysts in the liquid phase.

The process according to the invention is suitable both for performance at low temperatures, for example from −78 to 0° C., and at higher temperatures, i.e. at least 0° C., for example from 0 to 100° C. For economic reasons in particular, the polymerization is performed preferably at least 0° C., for example at from 0 to 100° C., more preferably at from 20 to 60° C., in order to minimize the energy and material consumption which is required for cooling. However, it can be carried out just as efficiently at lower temperatures, for example at from −78 to <0° C., preferably at from −40 to −10° C.

When the polymerization is effected at or above the boiling point of isobutene, it is preferably performed in pressure vessels, for example in autoclaves or pressure reactors.

Preference is given to performing the polymerization in the presence of an inert diluent. The inert diluent used should be suitable for reducing the increase in the viscosity, which generally occurs during the polymerization reaction, of the reaction solution to such an extent that the removal of the heat of reaction formed can be ensured. Suitable diluents are those solvents or solvent mixtures which are inert toward the reagents used. Suitable diluents are, for example, aliphatic hydrocarbons such as butane, pentane, hexane, heptane, octane and isooctane, cycloaliphatic hydrocarbons such as cyclopentane and cyclohexane, aromatic hydrocarbons such as benzene, toluene and the xylenes, and halogenated hydrocarbons such as methyl chloride, dichloromethane and trichloromethane, and also mixtures of the aforementioned diluents. Preference is given to using at least one halogenated hydrocarbon, if appropriate in a mixture with at least one of the aforementioned aliphatic or aromatic hydrocarbons. In particular, dichloromethane is used. Preference is given to freeing the diluents of impurities such as water, carboxylic acids or mineral acids before they are used, for example by adsorption on solid adsorbents such as activated carbon, molecular sieves or ion exchangers.

Preference is given to performing the polymerization under substantially aprotic, especially under anhydrous, reaction conditions. Aprotic and anhydrous reaction conditions are understood to mean that the water content (or the content of protic impurities) in the reaction mixture is less than 50 ppm and in particular less than 5 ppm. In general, the feedstocks will therefore be dried physically and/or by chemical measures before they are used. In particular, it has been found to be useful to admix the aliphatic or alicyclic hydrocarbons used as solvents, after customary prepurification and predrying, with an organometallic compound, for example an organolithium, organomagnesium or organoaluminum compound, in an amount which is sufficient to remove the water traces from the solvent. The solvent thus treated is then preferably condensed directly into the reaction vessel. It is also possible to proceed in a similar manner with the monomers to be polymerized, especially with isobutene or with the isobutenic mixtures. It is also suitable to dry with other customary dessicants such as molecular sieves or predried oxides such as aluminum oxide, silicon dioxide, calcium oxide or barium oxide. The halogenated solvents for which drying with metals such as sodium or potassium, or with metal alkyls is not possible, are freed of water (traces) with desiccants suitable for this purpose, for example with calcium chloride, phosphorus pentoxide or molecular sieves. It is also possible in a similar manner to dry the vinylaromatic monomers and also other feedstocks for which treatment with metal alkyls is likewise not an option.

The monomers are polymerized spontaneously when the initiator system (i.e. catalyst I) is mixed with at least one of the monomers at the desired reaction temperature. The procedure here may be to initially charge the monomers, if appropriate in the solvent, and then to add the catalyst I. The reaction temperature can be adjusted before or after the catalyst addition. The procedure may also be to initially charge only one of the monomers, if appropriate in the solvent, then to add the catalyst I and only after a certain time, for example when at least 60%, at least 80% or at least 90% of the monomer has reacted, to add the further monomer(s). Alternatively, the catalyst I, if appropriate in the solvent, can be initially charged, then the monomers added simultaneously or successively and then the desired reaction temperature established. The start of polymerization is regarded as being that time at which the catalyst and at least one of the monomers are present in the reaction vessel.

In addition to the batchwise procedure described here, it is also possible to configure the polymerization as a continuous process. In this case, the feedstocks, i.e. the monomers to be polymerized, the solvent if appropriate and the catalyst, are fed continuously to the polymerization reaction and reaction product is removed continuously, so that more or less steady-state polymerization conditions are established in the reactor. The monomers to be polymerized may be added as such, diluted with a solvent or as a monomer-containing hydrocarbon stream.

To terminate the reaction, the reaction mixture is preferably deactivated, for example by adding a protic compound, in particular by adding water, alcohols such as methanol, ethanol, n-propanol and isopropanol or mixtures thereof with water, or by adding an aqueous base, for example an aqueous solution of an alkali metal or alkaline earth metal hydroxide such as sodium hydroxide, potassium hydroxide, magnesium hydroxide or calcium hydroxide, of an alkali metal or alkaline earth metal carbonate such as sodium carbonate, potassium carbonate, magnesium carbonate or calcium carbonate, or of an alkali metal or alkaline earth metal hydrogencarbonate such as sodium hydrogencarbonate, potassium hydrogencarbonate, magnesium hydrogencarbonate or calcium hydrogencarbonate.

In a preferred embodiment, the process according to the invention serves to prepare copolymers from monomers comprising isobutene or an isobutenic hydrocarbon mixture and at least one vinylaromatic compound with a content of terminal vinylidene double bonds (α-double bonds) of at least 50 mol %. The process according to the invention more preferably serves to prepare highly reactive copolymers with a content of terminal vinylidene double bonds of at least 60 mol %, preferably of at least 70 mol %, particularly preferably of at least 80 mol %, more preferably of at least 85 mol % and in particular of at least 90 mol %, for example of at least 95 mol % or of about 100 mol %. The copolymer is preferably an isobutene-styrene copolymer.

The copolymer is preferably a block copolymer which comprises at least one isobutene block and at least one block of vinylaromatic compounds, the block of vinylaromatic compounds preferably being a styrene block. The process according to the invention can be configured in such a way that copolymers form which have, as terminal, i.e. last-formed, blocks, either polyisobutene blocks or blocks which derive from the vinylaromatic compound. However, the process according to the invention preferably serves to prepare copolymers with a terminal polyisobutene block. The block copolymer is more preferably a diblock copolymer which is formed from a polyisobutene block and a vinylaromatic block, the terminal block preferably being a polyisobutene block. The block of vinylaromatic compounds is more preferably a styrene block.

The copolymers prepared by the process according to the invention preferably have a number-average molecular weight Mₙ of from 500 to 1 000 000. The process according to the invention can be configured by selection of the appropriate reaction conditions such that, depending on the end use of the polymers, preferentially copolymers having a higher molecular weight or preferentially copolymers having a lower molecular weight are obtained. The variation in the reaction parameters required to obtain copolymers with a certain molecular weight is known in principle to those skilled in the art. When the intention is to use the copolymers prepared by the process according to the invention, for example, as thermoplastics, they have a number-average molecular weight Mₙ of preferably from 10 000 to 1 000 000, more preferably from 50 000 to 1 000 000 and in particular from 50 000 to 500 000. When the intention is to subject the copolymers prepared by the process according to the invention, for example, to the functionalization reactions described below, they have a number-average molecular weight Mₙ of preferably from 500 to 250 000, particularly preferably from 500 to 100 000, more preferably from 500 to 80 000 and in particular from 1000 to 60 000.

The process according to the invention can be performed successfully not only at temperatures of at least 0° C.; it can additionally be configured readily such that preferentially highly reactive copolymers, more preferably highly reactive block copolymers, are formed.

For monomer conversion of at least 80%, a polymerization time of at most 2 hours, more preferably of at most one hour, is preferably required.

The present invention further provides a copolymer formed from monomers comprising isobutene and at least one vinylaromatic compound, which is obtainable by the polymerization process according to the invention. The inventive copolymers preferably have a content of terminal vinylidene double bonds (α-double bonds) of at least 50 mol %. The inventive copolymers are more preferably highly reactive, i.e. they have a high content of terminal vinylidene double bonds (α-double bonds), for example of at least 60 mol %, preferably of at least 70 mol %, particularly preferably of at least 80 mol %, more preferably at least 85 mol % and in particular of at least 90 mol %, for example of at least 95 mol %, or of about 100 mol %.

The vinylaromatic compound is preferably styrene or 4-methylstyrene and more preferably styrene. Accordingly, particularly preferred copolymers are isobutene-styrene copolymers.

In the inventive copolymer, the total content of copolymerized vinylaromatic compound, based on the total weight of the polymer, is preferably from 5 to 95% by weight and more preferably from 30 to 70% by weight.

The inventive copolymer is preferably a block copolymer, for example a diblock, triblock or a higher block copolymer, which comprises at least one polyisobutene block and at least one block of vinylaromatic compounds, the block of vinylaromatic compounds preferably being a styrene block. The polyisobutene block is preferably the terminal, i.e. the last-formed, block. The block copolymer is more preferably a diblock copolymer which is formed from one polyisobutene block and one vinylaromatic block, the terminal block preferably being a polyisobutene block. The block of vinylaromatic compounds is more preferably a styrene block.

The inventive copolymers preferably have a number-average molecular weight Mₙ of preferably from 500 to 1 000 000. Depending on the end use, the inventive copolymers preferably have a higher molecular weight or preferably have a lower molecular weight. When the intention is to use the inventive copolymers, for example, as thermoplastics, they have a number-average molecular weight Mₙ of preferably from 10 000 to 1 000 000, more preferably from 50 000 to 1 000 000 and in particular from 50 000 to 500 000. When the intention is to subject the inventive copolymers, for example, to the functionalization reactions described below, they have a number-average molecular weight Mₙ of preferably from 500 to 250 000, particularly preferably from 500 to 100 000, more preferably from 500 to 80 000 and in particular from 1000 to 60 000.

The data given in the context of the invention for weight-average and number-average molecular weights M_{w} and Mₙ and their quotient PDI (PDI=M_{w}/Mₙ) relate to values which have been determined by means of gel permeation chromatography. The proportion of terminal ethylenic double bonds was determined by means of ¹H NMR.

Inventive copolymers cannot only be functionalized on the vinylidene-terminated chain ends analogously to highly reactive polyisobutenes in order to optimize them for a certain use; they additionally have thermoplastic and elastic properties. In particular, they or their functionalization products are suitable for use in films, sealant materials, adhesives, adhesion promoters, medical products, for example in the form of certain implants, in particular arterial implants (stents), and compounds.

The functionalization can be effected analogously to derivatization reactions as described, for example, in WO 03/074577 or in the German patent application DE 102005002772.5, which are hereby fully incorporated by reference.

The present invention accordingly further provides a functionalized copolymer which is formed from monomers comprising isobutene and at least one vinylaromatic compound, obtainable by subjecting an inventive copolymer to one of the following functionalization reactions:
i) hydrosilylation,
ii) hydrosulfuration,
iii) electrophilic substitution on aromatics,
iv) epoxidation and, if appropriate, reaction with nucleophiles,
v) hydroboration and, if appropriate, oxidative cleavage,
vi) reaction with an enophile in an ene reaction,
vii) addition of halogens or hydrogen halides,
viii) hydroformylation and, if appropriate, hydrogenation or reductive amination of the resulting product, or
ix) copolymerization with an olefinically unsaturated dicarboxylic acid or a derivative thereof.

### i) Hydrosilylation

For functionalization, an inventive copolymer may be subjected to a reaction with a silane in the presence of a silylation catalyst to obtain a copolymer functionalized at least partly with silyl groups.

Suitable hydrosilylation catalysts are, for example, transition metal catalysts, the transition metal preferably being selected from Pt, Pd, Rh, Ru and Ir. The suitable platinum catalysts include, for example, platinum in finely divided form (“platinum black”), platinum chloride and platinum complexes such as hexachloroplatinic acid or divinyldisiloxane-platinum complexes, e.g. tetramethyldivinyldisiloxane-platinum complexes. Suitable rhodium catalysts are, for example, (RhCl(P(C₆H₅)₃)₃) and RhCl₃. Also suitable are RuCl₃ and IrCl₃. Suitable catalysts are also Lewis acids such as AlCl₃ or TiCl₄ and peroxides. It may be advantageous to use combinations or mixtures of the aforementioned catalysts.

Suitable silanes are, for example, halogenated silanes such as trichlorosilane, methyldichlorosilane, dimethylchlorosilane and trimethylsiloxydichlorosilane; alkoxysilanes such as methyldimethoxysilane, phenyldimethoxysilane, 1,3,3,5,5,7,7-heptamethyl-1,1-dimethoxytetrasiloxane, and trialkoxysilanes, e.g. trimethoxysilane and triethoxysilane, and acyloxysilanes. Preference is given to using trialkoxysilanes.

The reaction temperature in the silylation is preferably in a range from 0 to 140° C., more preferably from 40 to 120° C. The reaction is typically carried out under standard pressure, but may also be effected at elevated pressures, for example in the range from about 1.5 to 20 bar, or reduced pressures, for example from 200 to 600 mbar.

The reaction may be effected without solvent or in the presence of a suitable solvent. Preferred solvents are, for example, toluene, tetrahydrofuran and chloroform.

### ii) Hydrosulfuration

For functionalization, an inventive copolymer may be subjected to a reaction with hydrogen sulfide or a thiol such as alkyl thiols or aryl thiols, hydroxy mercaptans, amino mercaptans, thiocarboxylic acids or silanethiols to obtain a copolymer functionalized at least partly with thio groups.

Suitable hydro-alkylthio additions are described in J. March, Advanced Organic Chemistry, 4th Edition, publisher: John Wiley & Sons, p. 766-767, which is fully incorporated here by way of reference. The reaction may generally be effected either in the absence or in the presence of initiators, and in the presence of electromagnetic radiation. In the case of the addition of hydrogen sulfide, copolymers functionalized with thiol groups are obtained. The addition of hydrogen sulfide is effected preferably at temperatures below 100° C. and a pressure of from 1 to 50 bar, more preferably of about 10 bar. The addition is also effected preferably in the presence of a cation exchange resin such as Amberlyst 15. In the case of the reaction with thiols in the absence of initiators, the Markovnikov addition products to the double bond are generally obtained. Suitable initiators of the hydro-alkylthio addition are, for example, protic and Lewis acids such as concentrated sulfuric acid or AlCl₃, and acidic cation exchangers such as Amberlyst 15. Suitable initiators are also those which are capable of forming free radicals, such as peroxides or azo compounds. In the case of the hydro-alkylthio addition in the presence of these initiators, the anti-Markovnikov addition products are generally obtained. The reaction may also be effected in the presence of electromagnetic radiation of wavelength from 10 to 400 nm, preferably from 200 to 300 nm.

iii) Electrophilic Substitution on Aromatics

For derivatization, an inventive copolymer may be reacted with a compound which has at least one aromatic or heteroaromatic group in the presence of an alkylation catalyst. Suitable aromatic and heteroaromatic compounds, catalysts and reaction conditions of this Friedel-Crafts alkylation are described, for example, in J. March, Advanced Organic Chemistry, 4th Edition, publisher: John Wiley & Sons, p. 534-539, which is incorporated here by way of reference.

For the alkylation, preference is given to using an activated aromatic compound. Suitable aromatic compounds are, for example, alkylaromatics, alkoxyaromatics, hydroxyaromatics or activated heteroaromatics such as thiophenes or furans.

The aromatic hydroxyl compound used for the alkylation is preferably selected from phenolic compounds which have 1, 2 or 3 OH groups and may optionally have at least one further substituent. Preferred further substituents are C₁-C₈-alkyl groups and in particular methyl and ethyl. Preference is given in particular to compounds of the general formula

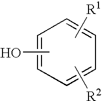

in which R¹ and R² are each independently hydrogen, OH or CH₃. Particular preference is given to phenol, the cresol isomers, catechol, resorcinol, pyrogallol, fluoroglucinol and the xylenol isomers. In particular, phenol, o-cresol and p-cresol are used. If desired, mixtures of the aforementioned compounds may also be used for the alkylation.

Also suitable are polyaromatics such as polystyrene, polyphenylene oxide or polyphenylene sulfide, or copolymers of aromatics, for example, with butadiene, isoprene, (meth)acrylic acid derivatives, ethylene or propylene.

The catalyst is preferably selected from Lewis-acidic alkylation catalysts, which refers in the context of the present application both to individual acceptor atoms and to acceptor-ligand complexes, molecules, etc., as long as they have, overall (externally), Lewis-acidic (electron acceptor) properties. They include, for example, AlCl₃, AlBr₃, BF₃, BF₃.2C₆H₅OH, BF₃.[O(C₂H₅)₂], TiCl₄, SnCl₄, AlC₂H₅Cl₂, FeCl₃, SbCl₅ and SbF₅. These alkylation catalysts may be used together with a cocatalyst, for example an ether. Suitable ethers are di-(C₁-C₈-)alkyl ethers such as dimethyl ether, diethyl ether, di-n-propyl ether and tetrahydrofuran, di-(C₅-C₈-)cycloalkyl ethers such as dicyclohexyl ether, and ethers having at least one aromatic hydrocarbon radical such as anisole. When a catalyst-cocatalyst complex is used for the Friedel-Crafts alkylation, the molar ratio of catalyst to cocatalyst is preferably in a range from 1:10 to 10:1. The reaction may also be catalyzed with protic acids such as sulfuric acid, phosphoric acid, methanesulfonic acid or trifluoromethanesulfonic acid. Organic protic acids may also be present in polymer-bound form, for example as the ion exchange resin. Also suitable are zeolites and inorganic polyacids.

The alkylation may be carried out without solvents or in a solvent. Suitable solvents are, for example, n-alkanes and mixtures thereof, and alkylaromatics such as toluene, ethylbenzene and xylene and halogenated derivatives thereof.

The alkylation is preferably carried out at temperatures between −10° C. and +100° C. The reaction is typically carried out at atmospheric pressure, but may also be carried out at higher pressures (for example in the case of volatile solvents) or at lower pressures.

Suitable selection of the molar ratios of aromatic or heteroaromatic compound to the copolymer and of the catalyst allows the achieved proportion of substituted products and their degree of substitution to be adjusted. Phenols substantially monosubstituted by the copolymer are generally obtained with an excess of phenol or in the presence of a Lewis-acidic alkylation catalyst when an ether is additionally used as a cocatalyst.

For further functionalization, the resulting phenol-substituted copolymer may be subjected to a reaction in the sense of a Mannich reaction with at least one aldehyde, for example formaldehyde, and at least one amine which has at least one primary or secondary amine function to obtain a compound which has been alkylated with the copolymer and additionally at least partly aminoalkylated. It is also possible to use reaction and/or condensation products of aldehyde and/or amine. The preparation of such compounds is described in WO 01/25 293 and WO 01/25 294, which are fully incorporated herein by way of reference.

### iv) Epoxidation

For functionalization, an inventive copolymer may be reacted with at least one peroxide compound to obtain an at least partly epoxidized copolymer.

Suitable processes for epoxidation are described in J. March, Advanced Organic Chemistry, 4th Edition, publisher: John Wiley & Sons, p. 826-829, which is incorporated here by way of reference. The peroxide compound used is preferably at least one peracid such as m-chloroperbenzoic acid, performic acid, peracetic acid, trifluoroperacetic acid, perbenzoic acid and 3,5-dinitroperbenzoic acid. The peracids can be prepared in situ from the corresponding acids and H₂O₂, if appropriate in the presence of mineral acids. Further suitable epoxidation reagents are, for example, alkaline hydrogen peroxide, molecular oxygen and alkyl peroxides such as tert-butyl hydroperoxide. Suitable solvents for the epoxidation are, for example, customary nonpolar solvents. Particularly suitable solvents are hydrocarbons such as toluene, xylene, hexane or heptane. The epoxide formed is relatively stable and may subsequently be ring-opened with water, acids, alcohols, thiols or primary or secondary amines to obtain, inter alia, diols, glycol ethers, glycol thioethers and amines. However, owing to the steric hindrance on the tertiary carbon atom of the epoxy group, this functionalization route frequently proceeds with relatively low yields. In contrast, when the epoxide is converted to the corresponding carbonyl compound, which may be effected, for example, by means of zeolites or Lewis acids, the carbonyl compounds formed can be derivatized with distinctly better yields by subjecting them, for example, to the reactions A) to C) described under ix).

The epoxide may additionally be converted to a 2-[copolymer]-1,3-propanediol by reaction with a borane and subsequent oxidative cleavage of the ester formed. Suitable boranes are, for example, diborane (B₂H₆) and alkyl- and arylboranes RBH₂ (R=alkyl or aryl). The reaction with the borane is effected suitably in a borane-coordinating solvent. Examples thereof are open-chain ethers such as dialkyl ethers, diaryl ethers or alkyl aryl ethers, and cyclic ethers such as tetrahydrofuran or 1,4-dioxane. The oxidative cleavage to the 1,3-diol may be effected, for example, as described in v). The conversion of the epoxide to a 2-[copolymer]-1,3-propanediol is described, for example, in EP-A-0737662, which is fully incorporated herein by way of reference.

### v) Hydroboration

For functionalization, an inventive copolymer may be subjected to a reaction with a borane (generated in situ if appropriate) to obtain an at least partly hydroxylated copolymer. Suitable processes for hydroboration are described in J. March, Advanced Organic Chemistry, 4th Edition, publisher: John Wiley & Sons, p. 783-789, which is incorporated herein by way of reference. Suitable hydroboration reagents are, for example, diborane which is generally generated in situ by reaction of sodium borohydride with BF₃ etherate, diisoamylborane (bis[3-methylbut-2-yl]borane), 1,1,2-trimethylpropylborane, 9-borobicyclo[3.3.1]nonane, diisocamphenylborane, which are obtainable by hydroboration of the corresponding alkenes with diborane, chloroborane-dimethyl sulfide, alkyldichloroboranes or H₃B—N(C₂H₅)₂.

Typically, the hydroboration is carried out in a solvent. Suitable solvents for the hydroboration are, for example, acyclic ethers such as diethyl ether, methyl tert-butyl ether, dimethoxyethane, diethylene glycol dimethyl ether, triethylene glycol dimethyl ether, cyclic ethers such as tetrahydrofuran or dioxane, and hydrocarbons such as hexane or toluene, or mixtures thereof. The reaction temperature is generally determined by the reactivity of the hydroboration agent and is normally between the melting point and boiling point of the reaction mixture, preferably in the range from 0° C. to 60° C.

Typically, the hydroboration agent is used in excess based on the alkene. The boron atom adds preferentially to the less substituted and thus less sterically hindered carbon atom.

Typically, the copolymer-substituted boranes formed are not isolated, but rather converted directly to the products of value by subsequent reaction. A very important reaction of the copolymer-substituted boranes is the reaction with alkaline hydrogen peroxide to obtain an alcohol, which preferably corresponds formally to the anti-Markovnikov hydration of the copolymer. In addition, the resulting copolymer-substituted boranes may be subjected to a reaction with bromine in the presence of hydroxide ions to obtain the bromide.

### vi) Ene Reaction

For functionalization, an inventive copolymer may be reacted in an ene reaction with at least one alkene which has an electrophile-substituted double bond (see, for example, DE-A 4 319 672 or H. Mach and P. Rath in “Lubrication Science II” (1999), p. 175-185, which is fully incorporated by reference). In the ene reaction, an alkene having a hydrogen atom in the allyl position, referred to as ene, is reacted with an electrophilic alkene, known as the enophile, in a pericyclic reaction comprising a carbon-carbon bond formation, a double bond shift and a hydrogen transfer. In the present context, the copolymer reacts as the ene. Suitable enophiles are compounds as are also used as dienophiles in the Diels-Alder reaction. The enophile used is preferably maleic anhydride. This results in copolymers functionalized at least partly with succinic anhydride groups. Depending on the molecular weight and on the double bond type of the copolymer used, the maleic anhydride concentration and the temperature, generally from 70 to 90% of the copolymer used is functionalized. The double bond newly formed in the copolymer chain may subsequently be further functionalized if desired, for example by reacting with maleic anhydride in a new ene reaction with attachment of a further succinic anhydride group.

The ene reaction may, if appropriate, be carried out in the presence of a Lewis acid as a catalyst. Suitable Lewis acid catalysts are, for example, aluminum chloride and ethylaluminum chloride.

For further functionalization, a copolymer derivatized with succinic anhydride groups, for example, can be subjected to a subsequent reaction which is selected from:
a) reaction with at least one amine to obtain a copolymer functionalized at least partly with succinimide groups and/or succinamide groups,
b) reaction with at least one alcohol to obtain a copolymer functionalized at least partly with succinic ester groups, and
c) reaction with at least one thiol to obtain a copolymer functionalized at least partly with succinic thioester groups.
   vii) Addition of Halogen or Hydrogen Halides

For functionalization, an inventive copolymer may be subjected to a reaction with hydrogen halide or a halogen to obtain a copolymer functionalized at least partly with halogen groups. Suitable reaction conditions of the hydro-halo addition are described in J. March, Advanced Organic Chemistry, 4th Edition, publisher: John Wiley & Sons, p. 758-759, which is incorporated here by way of reference. Suitable for the addition of hydrogen halide are in principle HF, HCl, HBr and HI. The addition of HI, HBr and HF may generally be effected at room temperature, whereas elevated temperatures and/or elevated pressure are generally used for the addition of HCl.

The addition of hydrogen halides may in principle be effected in the absence or in the presence of initiators or of electromagnetic radiation. In the case of the addition in the absence of initiators, especially of peroxides, the Markovnikov addition products are generally obtained. With addition of peroxides, the addition of HBr leads generally to anti-Markovnikov products.

The halogenation of double bonds is described in J. March, Advanced Organic Chemistry, 4th Edition, publisher: John Wiley & Sons, p. 812-814, which is incorporated here by way of reference. For the addition of Cl, Br and I, the free halogens may be used. To obtain compounds of mixed halogenation, the use of interhalogen compounds is known. For the addition of fluorine, fluorine compounds such as CoF₃, XeF₂ and mixtures of PbO₂ and SF₄ are generally used. Bromine generally adds at room temperature in good yields to double bonds. For the addition of chlorine, in addition to the free halogen, chlorine reagents such as SO₂Cl₂, PCl₅, etc. may also be used.

The dihalides formed may, if desired, be dehydrohalogenated, for example by thermal treatment, in which case allyl halide-terminated copolymers are then obtained.

When chlorine or bromine are used for halogenation in the presence of electromagnetic radiation, substantially the products of free-radical substitution on the polymer chain and not, or only to a minor degree, addition products to the terminal double bond are obtained.

viii) Hydroformylation

For functionalization, the inventive copolymer may be subjected to a reaction with carbon monoxide and hydrogen in the presence of a hydroformylation catalyst to obtain an at least partly hydroformylated copolymer. It will be appreciated that the reaction conditions are selected such that the aromatic rings of the copolymerized vinylaromatic compounds are not changed.

Suitable catalysts for the hydroformylation are known and preferably comprise a compound or a complex of an element of transition group VIII of the Periodic Table, such as Co, Rh, Ir, Ru, Pd or Pt. To influence the activity and/or selectivity, preference is given to using hydroformylation catalysts modified with N or P ligands. Suitable salts of these metals are, for example, the hydrides, halides, nitrates, sulfates, oxides, sulfides or the salts with alkyl- or arylcarboxylic acids or alkyl- or arylsulfonic acids. Suitable complexes have ligands which are, for example, selected from halides, amines, carboxylates, acetylacetonate, aryl- or alkylsulfonates, hydride, CO, olefins, dienes, cycloolefins, nitriles, N-containing heterocycles, aromatics and heteroaromatics, ethers, PF₃, phospholes, phosphabenzenes, and mono-, di- and multidentate phosphine, phosphinite, phosphonite, phosphoramidite and phosphite ligands.

In general, catalytically active species of the general formula HₓM_{y}(CO)_{z}L_{q} where M is a metal of transition group VIII, L is a ligand and q, x, y, z are integers depending on the valency and type of the metal and on the valency of the ligand L are formed under hydroformylation conditions from the catalysts or catalyst precursors used in each case.

In a preferred embodiment, the hydroformylation catalysts are prepared in situ in the reactor used for the hydroformylation reaction.

Another preferred form is the use of a carbonyl generator in which presynthesized carbonyl is adsorbed, for example, on activated carbon and only the desorbed carbonyl is fed to the hydroformylation, but not the salt solutions from which the carbonyl is generated.

Suitable rhodium compounds and complexes are, for example, rhodium(II) and rhodium(III) salts such as rhodium(III) chloride, rhodium(III) nitrate, rhodium(III) sulfate, potassium rhodium sulfate, rhodium(II) or rhodium(III) carboxylate, rhodium(II) and rhodium(III) acetate, rhodium(III) oxide, salts of rhodium(III) acid, trisammoniumhexachlororhodate(III), etc. Also suitable are rhodium complexes such as rhodium biscarbonyl acetylacetonate, acetylacetonatobisethylenerhodium(I), etc.

Likewise suitable are ruthenium salts or compounds. Suitable ruthenium salts are, for example, ruthenium(III) chloride, ruthenium(IV), ruthenium(VI) or ruthenium(VIII) oxide, alkali metal salts of the ruthenium-oxygen acids such as K₂RuO₄ or KRuO₄ or complexes, for example RuHCl(CO)(PPh₃)₃. It is also possible to use the metal carbonyls of ruthenium such as trisruthenium dodecacarbonyl or hexaruthenium octadecacarbonyl, or mixed forms in which CO has been replaced partly by ligands of the formula PR₃, such as Ru(CO)₃(PPh₃)₂.

Suitable cobalt compounds are, for example, cobalt(II) chloride, cobalt(II) sulfate, cobalt(II) carbonate, cobalt(II) nitrate, amine or hydrate complexes thereof, cobalt carboxylates such as cobalt formate, cobalt acetate, cobalt ethylhexanoate, cobalt naphthanoate, and the cobalt caprolactamate complex. It is also possible here to use the carbonyl complexes of cobalt such as dicobalt octacarbonyl, tetracobalt dodecacarbonyl and hexacobalt hexadecacarbonyl.

The compounds mentioned and further suitable compounds are known in principle and described sufficiently in the literature.

Suitable activating agents which may be used for the hydroformylation are, for example, Brønsted acids, Lewis acids, for example BF₃, AlCl₃, ZnCl₂, and Lewis bases.

The composition of the synthesis gas, composed of carbon monoxide and hydrogen, used may vary within wide ranges. The molar ratio of carbon monoxide and hydrogen is generally from about 5:95 to 95:5, preferably from about 40:60 to 60:40. The temperature in the hydroformylation is generally in a range from about 20 to 200° C., preferably from about 50 to 190° C. The reaction is generally carried out at the partial pressure of the reaction gas at the selected reaction temperature. In general, the pressure is in a range from about 1 to 700 bar, preferably from 1 to 300 bar.

The carbonyl number of the resulting hydroformylated copolymers depends upon the number-average molecular weight Mₙ.

The predominant portion of the double bonds present in the inventive copolymer used is preferably converted to aldehydes by the hydroformylation. Use of suitable hydroformylation catalysts and/or an excess of hydrogen in the synthesis gas used allows the predominant portion of the ethylenically unsaturated double bonds present in the reactant also to be converted directly to alcohols. This can also be effected in a two-stage functionalization according to the reaction step B) described below.

The functionalized copolymers obtained by hydroformylation are suitable advantageously as intermediates for the further processing by functionalization of at least a portion of the aldehyde functions present therein.

### A) Oxo Carboxylic Acids

For further functionalization, the hydroformylated copolymers obtained in step viii) can be reacted with an oxidizing agent to obtain a copolymer functionalized at least partly with carboxyl groups.

For the oxidation of aldehydes to carboxylic acids, a large number of different oxidizing agents and processes may generally be used, which are described, for example, in J. March, Advanced Organic Chemistry, publisher: John Wiley & Sons, 4th Edition, p. 701ff. (1992). These include, for example, the oxidation with permanganate, chromate, atmospheric oxygen, etc. The oxidation with air may be effected either catalytically in the presence of metal salts or in the absence of catalysts. The metals used are preferably those which are capable of a change of valency, for example Cu, Fe, Co, Mn, etc. The reaction generally also succeeds in the absence of a catalyst. In the case of air oxidation, the conversion may be controlled readily via the reaction time.

In a further embodiment, the oxidizing agent used is an aqueous hydrogen peroxide solution in combination with a carboxylic acid, for example acetic acid. The acid number of the resulting copolymers with carboxyl function depends on the number-average molecular weight Mₙ.

### B) Oxo Alcohols

In a further suitable embodiment, the hydroformylated copolymers obtained in step viii) may be subjected to a reaction with hydrogen in the presence of a hydrogenation catalyst to obtain a copolymer functionalized at least partly with alcohol groups. It will be appreciated that the reaction conditions are selected such that the aromatic rings of the copolymerized vinylaromatic compounds are not changed.

Suitable hydrogenation catalysts are generally transition metals, for example Cr, Mo, W, Fe, Rh, Co, Ni, Pd, Pt, Ru, etc., or mixtures thereof, which may be applied to supports, for example activated carbon, alumina, kieselguhr, etc., to increase the activity and stability. To increase the catalytic activity, Fe, Co and preferably Ni may also be used in the form of the Raney catalysts as metal sponge with a very large surface area.

The hydrogenation of the oxo aldehydes from stage viii) is effected, depending on the activity of the catalyst, preferably at elevated temperatures and elevated pressure. The reaction temperature is preferably from about 80 to 150° C. and the pressure from about 50 to 350 bar.

The alcohol number of the resulting copolymers with hydroxyl groups depends on the number-average molecular weight Mₙ.

### C) Amine Synthesis

In a further suitable embodiment, the hydroformylated copolymers obtained in step viii) are subjected for further functionalization to a reaction with hydrogen and ammonia or a primary or secondary amine in the presence of an amination catalyst to obtain a copolymer functionalized at least partly with amine groups. It will be appreciated that the reaction conditions are selected such that the aromatic rings of the copolymerized vinylaromatic compounds are not changed.

Suitable amination catalysts are the hydrogenation catalysts described above in stage B), preferably copper, cobalt or nickel, which may be used in the form of the Raney metals or on a support. Also suitable are platinum catalysts.

In the amination with ammonia, aminated copolymers having predominantly primary amino functions are obtained. Primary and secondary amines suitable for the amination are compounds of the general formulae R—NH₂ and RR′NH where R and R′ are each, for example, C₁-C₁₀-alkyl, C₆-C₂₀-aryl, C₇-C₂₀-arylalkyl, C₇-C₂₀-alkylaryl or cycloalkyl. Diamines such as N,N-dimethylaminopropylamine and N,N′-dimethylpropylene-1,3-diamine are also suitable.

The amine number of the resulting copolymers with amino function depends on the number-average molecular weight Mₙ and on the number of amino groups incorporated.

ix) Copolymerization with Olefinically Unsaturated Dicarboxylic Acids

The copolymerization of the inventive copolymers having unsaturated termination with unsaturated dicarboxylic acids such as maleic acid or fumaric acid, or suitable derivatives thereof such as maleic anhydride, maleic esters or fumaric esters, is described in EP-A-0644208, which is fully incorporated here by way of reference. The resulting copolymers may subsequently be derivatized further, for example by esterification or transesterification on the carboxyl groups of the dicarboxylic acid building block used, or by their reaction with mono-, di- or polyamines to give the corresponding ammonium salts or amides, and, in the case of the use of maleic acid or derivatives thereof as a comonomer, also to give imides, diimides or polyimides.

Preferred functionalization products are copolymers with succinic acid groups, especially with succinic anhydride or with succinimide groups.

The invention will now be illustrated by the nonlimiting examples which follow.

### EXAMPLES

### General

All syntheses and reactions were effected under argon atmosphere using Schlenk technology. Methylene chloride was dried over calcium hydride, n-hexane was dried over sodium/benzophenone and stored over 4 Å molecular sieve, and acetonitrile was dried over calcium hydride and stored over 3 Å molecular sieve.

The catalyst used was the compound of the formula I.1

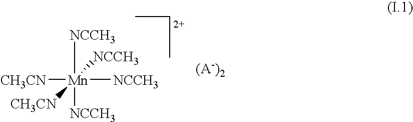

in which A⁻ is the anion of the following formula:

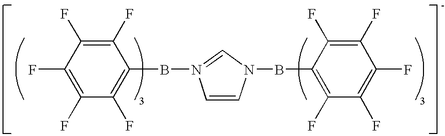

The catalyst was prepared analogously to the synthesis method of EP-A-1344785.

Polymerization reactions: copolymerization of isobutene and styrene

Pressure tubes were charged at −40° C. with 20 ml of dry dichloromethane and with the catalyst and a magnetic bar. Condensed isobutene and styrene were then added (experiment 1.1). The pressure tubes were sealed and removed from the cooling bath. The polymerization was performed in a water bath heated to the desired temperature. The polymerization was ended by adding 5 ml of methanol. The reaction mixture was admixed with 0.2 g of 2,2′-methylenebis(4-methyl-6-di-tert-butyl)phenol in order to prevent oxidation. The solvents were removed in an oil-pump vacuum and the resulting polymer was dried to constant weight in fine vacuum at 30° C. The polymers were stored under inert gas atmosphere.

In experiment 1.2, styrene was added initially and subjected to the above-described polymerization reaction. Only then was condensed isobutene added and polymerized as described above.

### Experiment 1.1

Reaction Conditions:

Isobutene concentration: 1.78 mol/l
Styrene concentration: 0.96 mol/l
Catalyst concentration: 0.5×10⁻⁴ mol/l

### Solvent: Dichloromethane

Reaction temperature: 30° C.
Polymerization time: 24 hours

Results:

### Conversion: 98.5%

Mₙ of the polymer: 1200
PDI of the polymer: 2.17

### Experiment 1.2

Reaction Conditions:

Isobutene concentration: 1.78 mol/l
Styrene concentration: 0.96 mol/l
Catalyst concentration: 0.5×10⁻⁴ mol/l

### Solvent: Dichloromethane

Reaction temperature: 30° C.
Polymerization time: 24+6 hours

Results:

### Conversion: 98.7%

Mₙ of the polymer: 1700
PDI of the polymer: 2.35

1. A process for preparing copolymers which are formed from monomers comprising isobutene and at least one vinylaromatic compound, which comprises polymerizing isobutene or an isobutenic hydrocarbon mixture and at least one vinylaromatic compound in the presence of a catalyst of the formula I
[M(L)ₐ(Z)_{b}]^{m+}m(A⁻) (I)
in which
M is a transition metal of group 3 to 12 of the periodic table, a lanthanide or a metal of group 2 or 13 of the periodic table;
L is a solvent molecule;
Z is a singly or multiply charged ligand;
A⁻ is a weakly coordinating or noncoordinating anion;
a is an integer greater than or equal to 1;
b is 0 or an integer greater than or equal to 1;
where the sum of a and b is from 4 to 8; and
m is an integer from 1 to 6.

2. The process according to claim 1 for preparing highly reactive copolymers which are formed from monomers comprising isobutene and at least one vinylaromatic compound.

3. The process according to claim 1, wherein the vinylaromatic compound is styrene.

4. The process according to claim 1, wherein the lanthanides are selected from cerium and samarium.

5. The process according to claim 1, wherein the metals of group 2 and 13 of the periodic table are selected from magnesium and aluminum.

6. The process according to claim 1, wherein M is selected from V, Cr, Mo, Mn, Fe, Co, Ni, Cu and Zn.

7. The process according to claim 6, wherein M is Mn.

8. The process according to claim 1, wherein the solvent molecules L are the same or different and are selected from nitriles of the formula N≡C—R¹ in which R¹ is C₁-C₈-alkyl or aryl, and open-chain and cyclic ethers.

9. The process according to claim 8, wherein L is a nitrile of the formula N≡C—R¹ in which R¹ is methyl, ethyl or phenyl.

10. The process according to claim 1, wherein Z is a charged monodentate ligand which is selected from halides, pseudohalides, hydroxyl, nitrite, alkoxides and the anions of aliphatic or aromatic monocarboxylic acids, or is a charged polydentate ligand which is selected from acetylacetonate, EDTA and the anions of aliphatic or aromatic dicarboxylic acids or polycarboxylic acids.

11. The catalyst according to claim 10, wherein Z is a halide or a pseudohalide.

12. The process according to claim 1, wherein A⁻ is selected from BX₄⁻, B(Ar)₄⁻, bridged anions of the formula [(Ar)₃B-(μ-Y)—B(Ar)₃]⁻, SbX₆⁻, Sb₂X₁₁⁻, AsX₆⁻, As₂X₁₁⁻, ReX₆⁻, Re₂X₁₁⁻, Al₂X₇⁻, OTeX₅⁻, B(OTeX₅)₄⁻, Nb(OTeX₅)₆⁻, [Zn(OTeX₅)₄]₂⁻, OSeX₅⁻, trifluoromethanesulfonate, perchlorate, carborates and carbon cluster anions, where
Ar is phenyl which may bear from 1 to 5 substituents which are selected from halogen, C₁-C₄-alkyl and C₁-C₄-haloalkyl;
Y is a bridging group; and
X is fluorine or chlorine.

13. The process according to claim 12, wherein Y is selected from cyclic bridging groups.

14. The process according to claim 12, wherein X is fluorine.

15. The process according to claim 12, wherein A⁻ is B(Ar)₄⁻ or [(Ar)₃B-(μ-Y)—B(Ar)₃]⁻.

16. The process according to claim 1, wherein a is an integer from 4 to 6.

17. The process according to claim 1, wherein b is 0 or 1.

18. The process according to claim 1, wherein m is an integer from 1 to 3.

19. The process according to claim 1, wherein polymerization is effected at a temperature of at least 0° C.

20. A highly reactive copolymer formed from monomers comprising isobutene and at least one vinylaromatic compound, obtainable by the process according to claim 1.

21. A functionalized copolymer which is formed from monomers comprising isobutene and at least one vinylaromatic compound, obtainable by subjecting the highly reactive copolymer according to claim 20 to one of the following functionalization reactions:
i) hydrosilylation,
ii) hydrosulfuration,
iii) electrophilic substitution on aromatics,
iv) epoxidation and, if appropriate, reaction with nucleophiles,
v) hydroboration and, if appropriate, oxidative cleavage,
vi) reaction with an enophile in an ene reaction,
vii) addition of halogens or hydrogen halides,
viii) hydroformylation and, if appropriate, hydrogenation or reductive amination of the resulting product, or
ix) copolymerization with an olefinically unsaturated dicarboxylic acid or a derivative thereof.
